(19) United States
(12) Patent Application Publication
(10) Pub. No.: US 2018/0319487 A1
(43) Pub. Date: Nov. 8, 2018

(54) Rotorcraft configuration

(71) Applicant: Ruben Maier, Cordoba (AR)

(72) Inventor: Ruben Maier, Cordoba (AR)

(73) Assignee: Ruben Maier, Cordoba (AR)

(21) Appl. No.: 15/589,709

(22) Filed: May 8, 2017

(51) Int. Cl. B64C 27/10; B64C 27/32; B64C 27/18

(52) U.S. Cl. CPC B64C 27/10; B64C 27/57; B64C 27/18; B64C 27/325

(57) ABSTRACT

This invention is about a rotorcraft that possesses a configuration made up of the join of three technologies Know separately as “Jet Tip”, “Circulation Control” and “Advancing Blade Concept”. These three technologies synergizes of unusual form allowing the embodiment of a rotorcraft with advantages qualitative and quantitative in fields as flight characteristics, manufacturing, maintenance, security in flight and operational costs.

### FIELD OF INVENTION

This invention is on a new helicopter configuration, which solves most problems of current actual helicopters, too called conventional helicopters. These problems are of construction, flight, maintenance, security, operation, and cost.

### DESCRIPTION OF PRIOR ART

The conventional helicopters have a main rotor that hold at the flight machine into the air, and a tail rotor that counteract the moment generated by the drag of blades when turn around the mast and provides yaw control on Z axis. The pitch and roll moment are provided by the cyclic control, tilting the main rotor disc about X and Y axis, this action tilt the trust vector added in normally way at rotor disc, this trust vector can be decomposed in a vertical and horizontal components, the vertical offset the weight of rotorcraft and the horizontal component slide the machine in both axis X and Y.

The tilt of rotor disc is achieved, by tilt the swash plate in order to change the blade pitch during each revolution and the blade moves his nose up and dawn, producing a vibration of first order, called flapped oscillation which introduces undesirable effects. This frequency of one per revolution combined with others of second and third order giving one of the worst features of conventional helicopters, penalizing the useful life of whole rotorcraft avionic, equipment, and aircrew health.

The complexity of rotor head is evident when we look it. The high loads transmitted to the rotor hub by the blades, determine the use of real or virtual hinges in the rotor hub on several directions, as: vertical, horizontal-tangential and horizontal-radial with dumpers, stoppers, and links, all this complex mechanisms are manufactured totally of high precision parts as well as main gear box, tail rotor, tail gear box, transmission and commands. All mechanical devices add cost, weight and failure possibility in conventional rotorcraft.

Other undesirable features of conventional helicopters are, high noise level; high instability in all flight regime; low speed comparatively at fixed wings, asymmetry of loads; low service ceiling; low climb rate, these bad characteristics are common at all conventional helicopters.

Many helicopters manufacturers and several laboratories had inverted all kinds of resources through decades in research and development to minimize this undesirables features of helicopters, making great achievements but not a whole solution that remove all wrong things.

### SUMMARY OF THIS INVENTION

This invention consists of the conjunction of three known technologies, which were never studied or tested together. They are “Jet Tip” (JT), “Control of Circulation” (CC) and “Advancing Blade Concept” (ABC).

It consists of the use of two overlapping, coaxial, counter-rotating rotors, known as “Advancing Blade Concept”, both rotors being powered by a source of compressed air that is injected through the bottom of the hollow shaft and closed at its upper end, with perforations at height of the rotating hubs, through which the air flows into the duct into the blade. A part of this flow exhaust through a nozzle located at the trailing edge of the blade tip, this technology is known as “Jet Tip”. The remaining flow go out through a long slot at the top of the rounded trailing edge, creating a sheet of flow that remain attached at rounded trailing edge by the Coanda effect. This technology is known as “Circulation Control”.

The propulsion rotor system by means of JT has the advantage to not transmit torsor moment to airframe, therefore is not needed tail rotor, tail boom, transmission and tail gear box, neither main gear boxes, practically are suppress all mechanical system, consequently roughly 40% of empty weight is saved and a same number in manufacturing costs. The JT avoids lagging moments thus do not needed the use of hinges or dampers, also prevents ground resonance, because do not exist shaft moment transmitted from the axis to the blade. Lack of clapping sound, characteristic of conventional driven shaft helicopters. The service ceiling and the climbing rate are far enhanced with JT technology due the low empty weight, leap takeoff are possible too. With JT technology exist the possibility to install a stationary mast (without rotation) with larges ball bearings, where the hubs turn, allow from this way that air go from the inner mast toward the blade duct to feed the JT and CC.

The stationary mast allow allocate antennas, sensors, parachute etc. at top mast. Another inherent feature of JT tech, is deicing function, due at compressed hot air into hollow blade. The security in flight and ground are obvious due the lack of tail rotor and low number of pieces in drive and control system. The JT also has the possibility to introduce a second source of power that consist at least in one gas pressurized tank, to be used only in emergency situations. The JT manufacturing, maintenance and operative cost are surprisingly low.

The join hub-blade are completely rigid, no flapping, no feathering, no lagging hinges, neither swash plate, command links, pitch links, pitch horns, stabilisers, push roods, scissors, dampers, a whole lack of mechanical precision pieces. The rotor head are aerodynamically clean and give more stability, high disc load, less vibration, low noise and more security. The CC also has the feature of possess negative drag, between a wide range of pitch angles, this represent roughly 30% of the total power available, that can be used for climbing, more payload, more speed, or simply to enhance the total performance, and the autorotation rate. Other nice property of CC, is the profile thickness for low drag, as thick as 40%, this give a great structural stiffness to design a rigid rotor with high specific load that allow low rotor diameter and less rotational speed and consequently possibility of increment the forward rotorcraft speed.

### Advantage of the Invention

The key of this invention, is the unusual synergy produced by the joint of the three technologies

JT-CC-ABC, First point to consider, a unique source of power: compressed air, at low pressure, (˜1.5 bar). The CC delay the compression waves in transonic flow, this allow reach Mach values of 0.9 at tips blades without loss efficiency. The ABC technology, provide symmetric load at each side of rotor avoiding all problems of conventional helicopters to reach high forward speed. The ABC has other merits as its dynamic stability, due to compensation of moments between both rotors that turn in opposite sense, avoiding cross coupling, gyroscopic effects and ground resonance. The JT has received only one bad review in the past for its poor performance due to the flow load loss, into the blade ducts. The airfoils used at the past were the same than actually used in conventional ones, 15 to 12% thick, this thickness yield a great flow load loss, due to its poor equivalent hydraulic diameter. The CC airfoils allow the use of thick airfoils like 40% at root and 20% at tips, therefore twice the equivalent hydraulic section blade, avoiding flow load loss. Also a high specific load on the disc of CC rotor allow a reduction on its diameter, hence a short duct of blade, go at same sense of reduction of flow load loss. In the facts, this is the most important point of synergy between JT and CC technology. Other convergence point is the reduction or negative drag on the CC airfoils therefore less amount of flow need to push into rotation the blade thus diminish flow caudal too.

The synergy between CC and ABC technologies is given by the insensibility of CC airfoils at pitch changes, this are necessary when the under blades cross the down wash of upper blade, this effect increases when closer the rotors, in fact, this insensibility allow allocate both rotor closely, hence result less drag and less weight. Other synergy between CC and ABC is that ABC use two rotors, thus half charge each one, for the CC airfoils, the optimum point of work, is low Cl thus low Cᵤ, this imply low requirements of air flow therefore low power.

The configuration for rotorcrafts here proposed obtain the commands of pitch and roll by tilt the mast on axis X and Y this replace the poisonous cyclic control of conventional helicopters, the command of yaw on Z axis is achieved by a clutches between each rotor and the mast who is stationary linked at fuselage airframe avoiding turn on Z axis, so is transferred rotational momentum from the rotors to the fuselage, other form to reach this command is by a short boom with two ruder tabs under down wash of rotors.

### BACKGROUND OF THE TECHNICAL ART

The state of art actually of the JT is the same to 1942 when “Dobelhoff Wn 342” a German helicopter had used this technology, then in 1953 the French “SO 1221 Djinn” was put into serial production. Some patents about JT are US 20130161444 A1 by Pegasus Helicopter Inc. “High efficiency hub for pressure jet helicopters”—U.S. Pat. No. 7,275,711B1 by Flanigan “Gas powered tip-jet driven compound VSTOL aircraft”

The CC technology never was put into practice due the inability to cross design barriers and technology limitations, only were performed in laboratory test and computational behaviors analysis. U.S. Pat. No. 3,713,750 A “Circulation Control Rotor System” by Williams R.

Prior art of ABC technology may be seen: U.S. Pat. No 8,128,034 B2 by Karem Aircraft “Rotors on multiple masts”—US 20150097075 Alby Sikorsky Aircraft Corp. “Yaw control of coaxial Rotors”. Sykorsky Company had built a prototype called S-69 ABC and more recently the X2prototype and the S-97 Rider prototype.

The threes technologies together never were put into practice, neither laboratories analysis, assays, project, much less prototypes. Only a computational analysis and tunnel test were made, for a rotor with CC and JT, called this study “Tipjet 80-inch Model Rotor Hover Test (test N 1198) by Naval Surface Warfare Center. Another analysts of feasibility of CC with JT is “Preliminary Design of Tip Jet Driven Heavy Lift Helicopters Incorporating Circulation Control” by Hughes Helicopters Inc.

The Present invention disclose that the three technologies JT, CC and ABC joined in a same rotorcraft possess a special synergy that never before was achieved, with features of quality and quantity, that exceed all expectations, in technical, security and economic fields.

### DRAWINGS

At only effect illustrative but not limitative of possible variations of embodiments, is illustrated as

FIG. 1: Show an axonometric embodiment of three technologies JT, CC and ABC.—1) Compressor.—2) Flexible duct.—3) Gimbaled mechanism that allow tilt the mast in two axes.—4) Mast of the rotors,—5) Hubs of rotors.—6) Rotor Blades.—7) High pressure gas reservoir for emergency use.—8) Valve for command the exit from reservoir gas.—9) Structure linking the mast and airframe.—10) Casing of ballistic parachute used in emergency situations

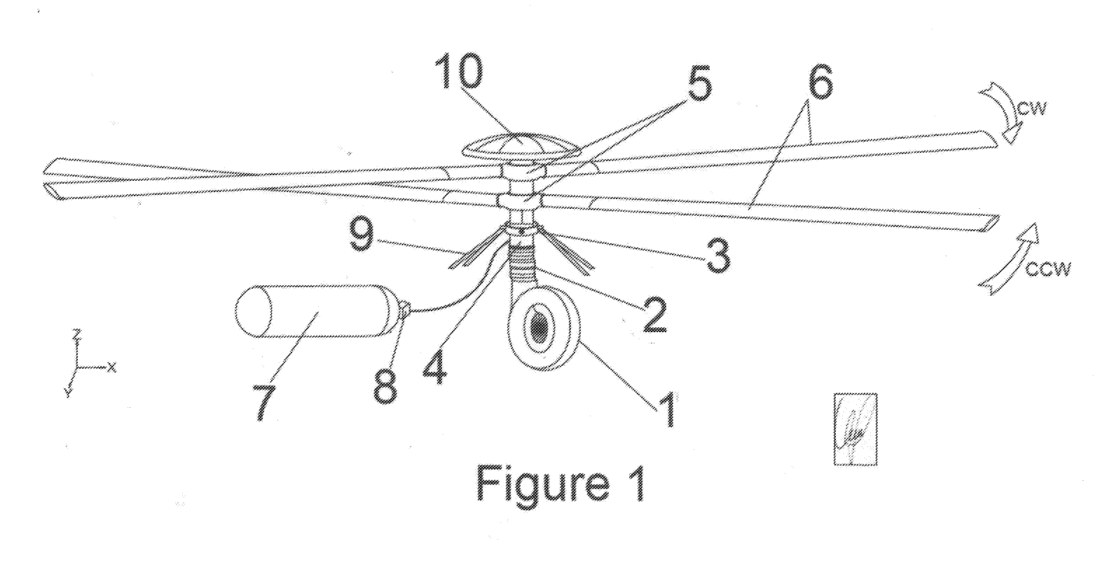

FIG. 2: Show a blade axonometric cutaway with its section—11) Air duct for Jet Tip propulsion blade.—12) Air duct for Circulation Control Supply.—13) Air slot ejection to create Circulation Control by Coanda effect on the rounded trailing edge.—14) Trailing edge of rounded section by Coanda effect.—15) Jet Tip nozzle.—16) Blade structural spar.

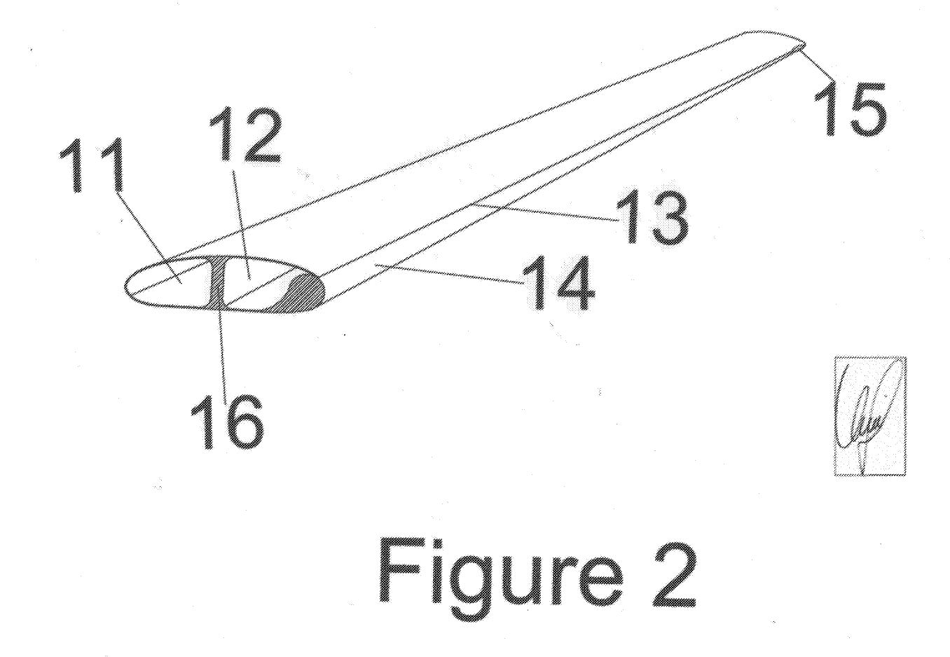

The invention claimed is:

1. A rotorcraft Characterized by possess two rotors superimposed, coaxially and contra rotating, with a hollow shaft (4) for both rotors; this shaft is part of a duct that carry air compressed; at bottom shaft is connected a hose (2) from the compressor (1), at top shaft is sealed and at level hubs (5), the shaft has a wall holes, whereby air through from inner shaft toward blade ducts (11) and (12) ejecting a part of air by the tip nozzle (15), for propulsion the blade into rotation as Jet Tip; the remaining air is ejected by a thin slot (13) along span blade on upper rounded trailing edge (14) like a thin air sheet, tangentially at trailing edge, creating Coanda effect, and thereby materializing the Circulation Control at the blades.

2. A rotorcraft as claim 1 characterized by possess a feed source of compressed air that consist in a reservoir of high pressure gas (7) connected at hollow shaft through a valve (8) that will open on emergency situations.

3. A rotorcraft as claim 1 Characterised by possess a command in roll and pitch, X and Y axis, controlled by tilt the shaft, through a gimbaled joint (3). This joint do not has free degree on Z axis, avoiding the rotation and displacement on Z axis.

4. A rotorcraft as claim 1 Characterised by possess a shaft or mast (4) stationary, without rotation on Z axis, turning the two hubs around it, in coaxial way.

5. A rotorcraft as Claim 1 and 4 Characterized by possess at top of its stationary mast, one casing (10) with at least one ballistic parachute, to use as last choice in emergency situations.

6. A rotorcraft as Claim 1 Characterized by possess a tail boom of elliptic section with double effect of Circulation Control, by double slot, at trailing edge, ejecting flow of differentially way, turning CW or CCW on Z axis, to achieve yaw control.

7. A rotorcraft as Claim 1 and 4 Characterized by possess between each hub and the mast, one clutch, disposed in order to transfer rotational momentum in Z axis from one of the rotors at the mast, allowing the control in yaw of the aircraft.

8. A rotorcraft as Claim 1 Characterized by possess longitudinally into the blade a spar beam, dividing the original duct into two ducts one forward (11) dedicated exclusively for feed the Jet Tip nozzle and the rearward duct (12) exclusively for feed the Circulation Control by the slot along the trailing edge.

9. A rotorcraft as Claim 1 Characterised by to have a blade with at least one valve within, in order to control the air flow of any of the inner ducts.
